(19) United States
(12) Patent Application Publication
(10) Pub. No.: US 2026/0148347 A1
(43) Pub. Date: May 28, 2026

(54) METHOD AND DEVICE FOR PANORAMIC IMAGE ENHANCEMENT

(71) Applicant: INDUSTRIAL TECHNOLOGY RESEARCH INSTITUTE, HSINCHU (TW)

(72) Inventors: Po-Kai LIU, Hsinchu County (TW); Cheng Yun LIU, New Taipei City (TW); Yi-Yun TSAI, Kaohsiung City (TW); Chang-Hao YAU, New Taipei City (TW); Ching-Chieh LIN, Hsinchu City (TW); Chun-Lung LIN, Taipei City (TW)

(21) Appl. No.: 18/961,518

(22) Filed: Nov. 27, 2024

(51) Int. Cl. G06T 5/60; G06T 17/20

(52) U.S. Cl. CPC G06T 5/60; G06T 17/205; G06T 2207/20072

(57) ABSTRACT

A method for panoramic image enhancement comprises the following steps. A source image represented in a spherical format is received. A polygon sphere is created. A mesh graph is created according to the polygon sphere and information of the source image. Visual complexity analysis is performed on the mesh graph to determine a first subgraph of the mesh graph and a second subgraph of the mesh graph which has higher visual complexity than the first subgraph. Information of the first subgraph is enhanced based on a linear interpolation algorithm to generate a first enhanced graph. Information of the second subgraph is enhanced based on a neural network to generate a second enhanced graph. The first enhanced graph and the second enhanced graph are combined to generate an enhanced panoramic image.

### BACKGROUND

### Field of Invention

The present disclosure relates to a method and a device for panoramic image enhancement. More particularly, the present disclosure relates to a method and a device capable for visual feature enhancement of spherical panoramic images.

### Description of Related Art

Nowadays, consumer-grade VR360 cameras offer immersive video by capturing a 360-degree or 180-degree views of photo and videos which are mainly stored in equirectangular format. The advantage of the equirectangular projection is low computational complexity. Each equirectangular image is converted from a spherical image by mapping a sphere onto a plane, which can express complete 360-degree spatial information.

Based on the field of view (such as, 120 degrees) of typically extended reality head-mounted displays in a horizontal direction, the equirectangular images are desired to have about two to three times display resolution of the extended reality head-mounted displays to achieve maximum display resolutions of most extended reality head-mounted displays.

However, the resolutions of most of the immersive videos or images are less than two times display resolution of the extended reality head-mounted displays. Therefore, how to provide a method and a device for panoramic image enhancement are important issues in this field.

### SUMMARY

The present disclosure provides a method for panoramic image enhancement comprising the following steps. A source image represented in a spherical format is received. A polygon sphere is created. A mesh graph is created according to the polygon sphere and information of the source image. Visual complexity analysis is performed on the mesh graph to determine a first subgraph of the mesh graph and a second subgraph of the mesh graph which has higher visual complexity than the first subgraph. Information of the first subgraph is enhanced based on a linear interpolation algorithm to generate a first enhanced graph. Information of the second subgraph is enhanced based on a neural network to generate a second enhanced graph. The first enhanced graph and the second enhanced graph are combined to generate an enhanced panoramic image.

The present disclosure provides a device comprising a processing circuit and a memory. The memory is configured to store data and instructions. The processing circuit coupled to the memory to access the data and the instructions to perform the following steps. A polygon sphere is created. A mesh graph is created according to the polygon sphere and information of the source image. Visual complexity analysis is performed on the mesh graph to determine a first subgraph of the mesh graph and a second subgraph of the mesh graph which has higher visual complexity than the first subgraph. Information of the first subgraph is enhanced based on a linear interpolation algorithm to generate a first enhanced graph. Information of the second subgraph is enhanced based on a neural network to generate a second enhanced graph. The first enhanced graph and the second enhanced graph are combined to generate an enhanced panoramic image.

Summary, the method and device for panoramic image enhancement can enhance and enlarge the resolution (such as, 4K or 8K) of the source spherical panoramic image to generate an enhanced spherical panoramic image which has the desired resolution (such as, 16K).

### BRIEF DESCRIPTION OF THE DRAWINGS

The present disclosure can be more fully understood by reading the following detailed description of the embodiment, with reference made to the accompanying drawings as follows.

FIG. 1 depicts a schematic diagram of an equirectangular projection of a sphere according to some embodiments of the present disclosure.

FIG. 2 depicts a flow chart of a method for panoramic image enhancement according to some embodiments of the present disclosure.

FIG. 3 depicts a schematic diagram of a device for panoramic image enhancement according to some embodiments of the present disclosure.

FIG. 4 depicts a schematic diagram of a source image represented in a spherical format according to some embodiments of the present disclosure.

FIG. 5 depicts a schematic diagram of a polygon sphere according to some embodiments of the present disclosure.

FIG. 6 depicts a schematic diagram of a fragment of a polygon sphere in FIG. 5 according to some embodiments of the present disclosure.

FIG. 7 depicts a schematic diagram of a mesh graph according to some embodiments of the present disclosure.

FIG. 8A and FIG. 8B depict schematic diagrams of growing a minimum spanning tree according to some embodiments of the present disclosure.

FIG. 9A depicts a schematic diagram of determining a complexity of each of subsets of fragments according to some embodiments of the present disclosure.

FIG. 9B depicts a schematic diagram of operations to generate an enhanced panoramic image from a first subgraph and a second subgraph according to some embodiments of the present disclosure.

FIG. 10A to FIG. 10C depict schematic diagrams of polygon spheres according to some embodiments of the present disclosure.

### DETAILED DESCRIPTION

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. Description of the operation does not intend to limit the operation sequence. Any structures resulting from recombination of elements with equivalent effects are within the scope of the present disclosure. It is noted that, in accordance with the standard practice in the industry, the drawings are only used for understanding and are not drawn to scale. Hence, the drawings are not meant to limit the actual embodiments of the present disclosure. In fact, the dimensions of the various features may be arbitrarily increased or reduced for clarity of discussion. Wherever possible, the same reference numbers are used in the drawings and the description to refer to the same or like parts for better understanding.

In the description herein and throughout the claims that follow, unless otherwise defined, all terms have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In the description herein and throughout the claims that follow, the terms “comprise” or “comprising,” “include” or “including,” “have” or “having,” “contain” or “containing” and the like used herein are to be understood to be open-ended, i.e., to mean including but not limited to.

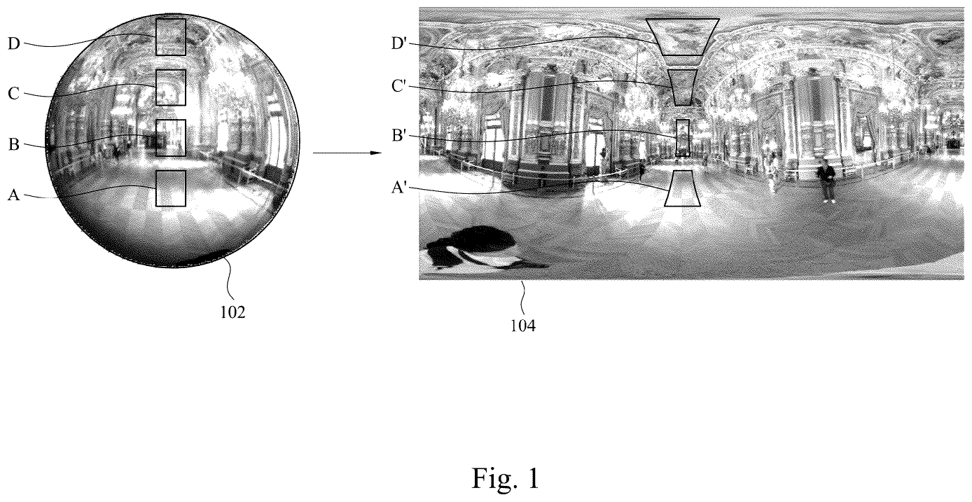

A description is provided with reference to FIG. 1. FIG. 1 depicts a schematic diagram of an equirectangular projection of a sphere according to some embodiments of the present disclosure. As shown in FIG. 1, the equirectangular projection can be considered as a cylinder wrapped around the sphere at the equator, as such a spherical image 102 can be mapped to an equirectangular image 104 which can represent 360-degree spatial information.

However, if a resolution of an source spherical image (such as, the spherical image 102) is less than two times display resolution of head-mounted displays, it may lead to a decrease in the output resolution of the head-mounted display because of the field of view.

Furthermore, in the equirectangular projection, the higher the latitude, the larger the exaggeration. For example, pixels in a regions A˜D of the sphere are respectively mapped to pixels in a region A′˜D′ in the equirectangular image 104, where one pixel in the region C is mapped to 1.3 pixels in a region C′ in the equirectangular image 104, and one pixel in the region D is mapped to 5.7 pixels in a region D′ in the equirectangular image 104. There may be greater distortion at the north and south poles, when the resolution of the source spherical image is lower. Therefore, the present disclosure provides a method for panoramic image enhancement.

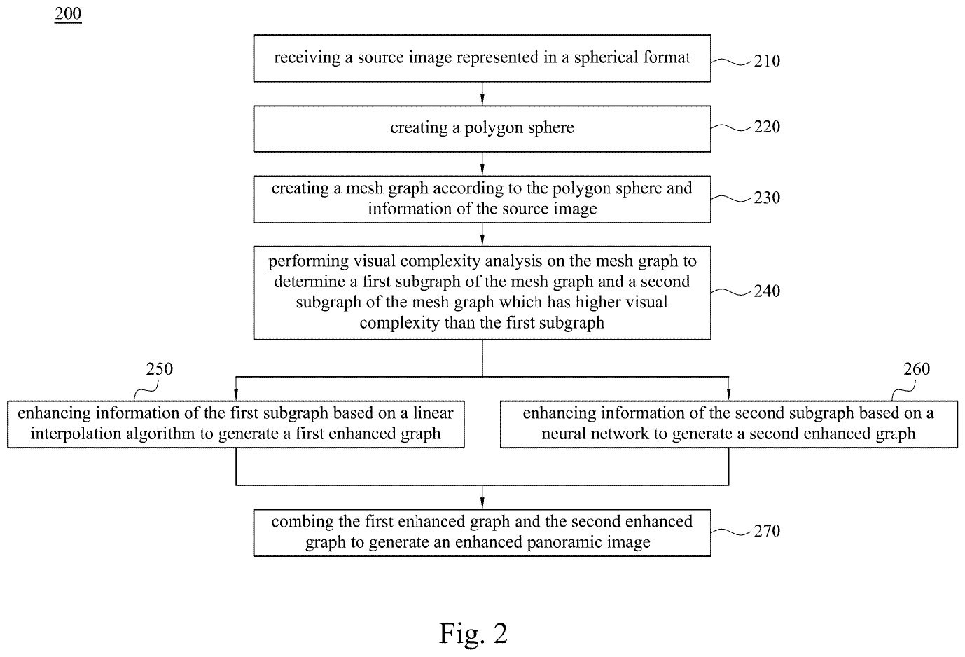

A description is provided with reference to FIG. 2. FIG. 2 depicts a flow chart of a method 200 for panoramic image enhancement according to some embodiments of the present disclosure. As shown in FIG. 2, the method 200 includes steps 210˜270.
Step 210 is executed to receive a source image represented in a spherical format. In some embodiments, the source image is a source spherical panoramic image which can be captured and processed by a VR360 camera. In some embodiments, a color space used in the source spherical panoramic image can be standard RGB, Adobe RGB or other color spaces; it is not intended to limit the present disclosure.
Step 220 is executed to create a polygon sphere. In some embodiments, the number of vertices of the polygon sphere depends on a desired resolution of a spherical panoramic image. In some embodiments, all of the vertices are evenly distributed on the polygon sphere.
Step 230 is executed to create a mesh graph according to the polygon sphere and information of the source image. In some embodiments, the information of the source image is projected to the polygon sphere, and the mesh graph inherits the data structure from the polygon sphere. In some embodiments, the mesh graph is a data structure, which includes multiple nodes, edges for representing the connection relationship of the nodes and features (such as, visual features or color information) of each node.
Step 240 is executed to perform visual complexity analysis on the mesh graph to determine a first subgraph of the mesh graph and a second subgraph of the mesh graph which has higher visual complexity than the first subgraph. In some embodiments, the visual complexity analysis is based on a minimum spanning tree algorithm and the color information in the mesh graph.
Step 250 is executed to enhance information of the first subgraph based on a linear interpolation algorithm to generate a first enhanced graph. In some embodiments, the color information in the first subgraph which has a lower visual complexity than the second subgraph can be enhanced by the linear interpolation algorithm to generate a first enhanced graph, thereby simplifying the computation for the low complexity region.
Step 260 is executed to enhance information of the second subgraph based on a neural network to generate a second enhanced graph. In some embodiments, compare to image in 2D dimension, an arrangement of the pixels on the spherical image in 3D dimension is not a linear arrangement. As a result, it is hard to directly perform convolution on the spherical image. Therefore, the neural network can be a graph convolution neural network to aggregate the visual features included in the second subgraph of the mesh graph to generate a second enhanced graph.
Step 270 is executed to combine the first enhanced graph and the second enhanced graph to generate an enhanced panoramic image. In some embodiments, the enhanced panoramic image has a resolution higher than the source image, and both of the enhanced panoramic image and the source image are spherical panoramic images.

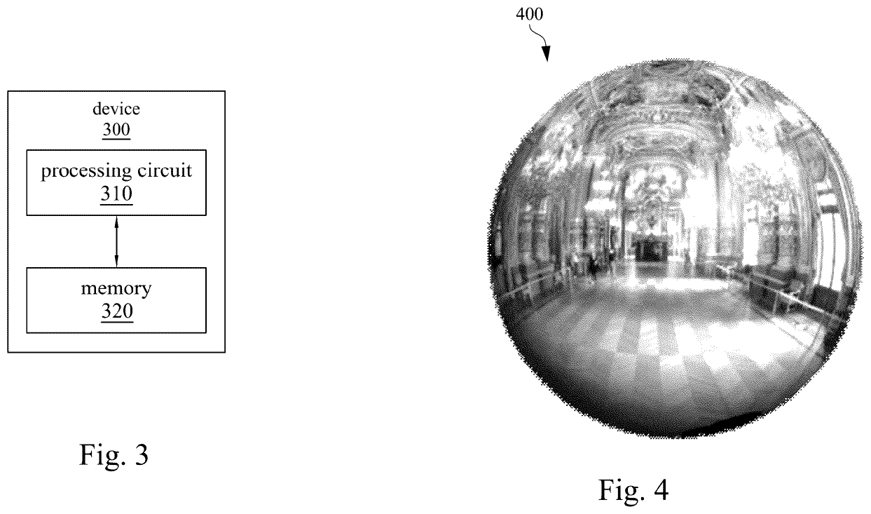

A description is provided with reference to FIG. 3. FIG. 3 depicts a schematic diagram of a device 300 for panoramic image enhancement according to some embodiments of the present disclosure. In some embodiments, the device 300 includes a processing circuit 310 and a memory 320. In some embodiments, the memory 320 is configured to store data and computer executable instructions, and the processing circuit 310 is configured to access the data and the instruction stored in the memory 320 to execute steps 210˜270 included in the method 200 of embodiments in FIG. 2.

In some embodiments, the processing circuit 310 includes central processing unit (CPU), graphic processing unit (GPU), tensor processing unit (TPU), application specific integrated circuit (ASIC) or any equivalent processing circuit. In some embodiments, the memory 320 can include dynamic memory, static memory, hard disk, flash memory and/or other memory devices.

A description is provided with reference to FIG. 4. FIG. 4 depicts a schematic diagram of a source image 400 represented in a spherical format according to some embodiments of the present disclosure. As shown in FIG. 4, the source image 400 is a source spherical panoramic image which can be captured and processing by a VR360 camera. In some embodiments, the color space of the source image 400 can be standard RGB, Adobe RGB or other color spaces. In some embodiments, the source image 400 has a resolution lower than a desired resolution (such as, 16K) of an output panoramic video for head mounted devices (such as, a head mounted device has a display resolution of 8K), where the value of the desired resolution depends on the display resolution and field of view of the head mounted device.

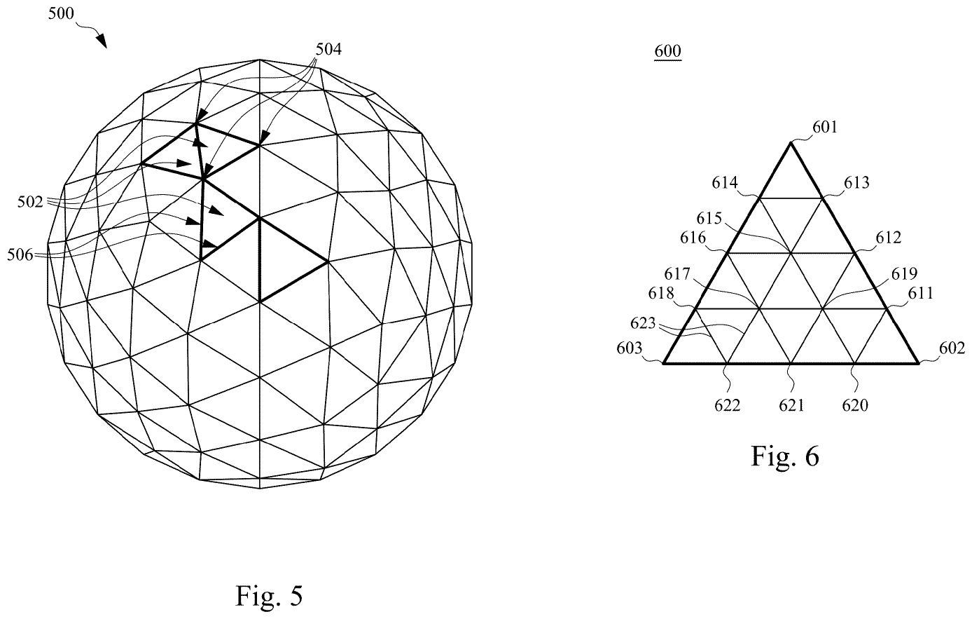

A description is provided with reference to FIG. 5. FIG. 5 depicts a schematic diagram of a polygon sphere 500 according to some embodiments of the present disclosure. As shown in FIG. 5, the polygon sphere 500 includes multiple vertices 504 and edges 506 to from fragments 502. In other words, the polygon sphere 500 is composed of fragments 502. In some embodiments, the positions of the vertices 504 can be represented by a spherical coordinate or a Cartesian coordinate, and the edges 506 for expressing the connection relationship among the vertices 504 can be expressed by a matrix, such as, an adjacency matrix in a k*k size, where the number of k is the number of all the vertices 504 of the polygon sphere 500.

In some embodiments, the vertices 504 which form the fragments 502 in FIG. 5 can be considered as basic vertices of the polygon sphere 500, and the number of all the vertices 504 of the polygon sphere 500 corresponding to a resolution of the source image (such as, the source image 400 in FIG. 4).

A description is provided with reference to FIG. 6. FIG. 6 depicts a schematic diagram of a fragment 600 of a polygon sphere 500 in FIG. 5 according to some embodiments of the present disclosure. In some embodiments, the polygon sphere 500 further includes vertices included in each fragment (such as, vertices 611˜622 included in the fragment 600) formed by the basic vertices (such as, basic vertices 601˜603). The vertices included in each fragment except the basic vertices can be considered as virtual vertices. The number of all of the basic vertices and the virtual vertices of the polygon sphere 500 corresponds to a desired resolution (such as, 16K) of an enhanced panoramic video. The number of all of the virtual vertices of the polygon sphere 500 corresponds to a difference between a resolution (such as, 8K) of the source image and the desired resolution (such as, 16K) of an enhanced panoramic video.

In some embodiments, the positions of the virtual vertices (such as, the virtual vertices 611˜622) can be represented by a spherical coordinate or a Cartesian coordinate. In some embodiments, all of the edges of the polygon sphere 500 (such as, edges 506 and 623) for expressing the connection relationship among the basic vertices and the virtual vertices of the polygon sphere 500 can be expressed by a matrix, such as, an adjacency matrix in a (k+j)*(k+j) size, where the number of k is the number of all the basic vertices (such as, the basic vertices 504) of the polygon sphere 500, and the number of j is the number of all the virtual vertices (such as, the virtual vertices 611˜622) of the polygon sphere 500.

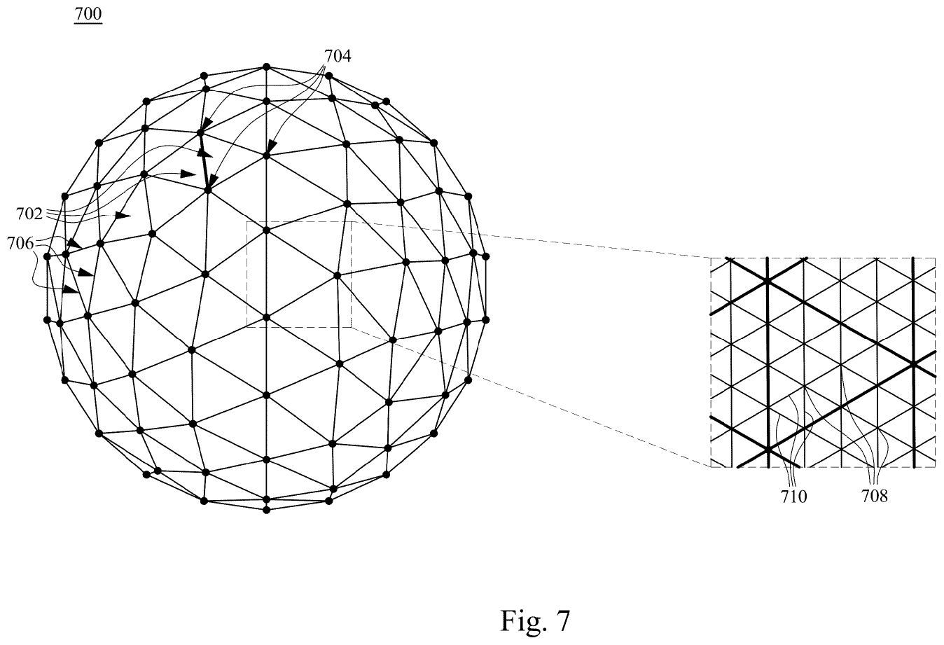

A description is provided with reference to FIG. 2 to FIG. 7. FIG. 7 depicts a schematic diagram of a mesh graph 700 according to some embodiments of the present disclosure. In some embodiments, the mesh graph 700 is created according to the structure of the polygon sphere 500 and the information of the source image 400. In some embodiments, the data structure of the mesh graph 700 is inherited from the polygon sphere 500, as such the mesh graph 700 includes basic vertices (such as, the vertices 704) which form the fragments (such as, the fragments 702), virtual vertices (such as, the vertices 708) and edges (such as, edges 706 and 710). In some embodiments, the color information of the source image 400 is projected to the basic vertices (such as, the vertices 704) as the visual feature of the mesh graph, while there is no visual feature on the virtual vertices (such as, the vertices 708) of the mesh graph 700. In other words, a feature matrix of the mesh graph 700 includes the visual features of the basic vertices, and a subset of the feature matrix for representing features of each of the virtual vertices is a null set. That is, the mesh graph includes basic vertices with visual features and virtual vertices without any visual feature. In some embodiments, the visual features of the basic vertices and vertex features (such as, the position of each vertex on the sphere) of the basic vertices and the virtual vertices are given by a feature matrix, and connection relationship among the basic vertices and the virtual vertices is given by an adjacency matrix. As a result, the mesh graph includes the feature matrix and the adjacency matrix. For example, the feature matrix includes visual features and vertex features (such as, the position on the sphere) on the k basic vertices and vertex features on the j virtual vertices, and the adjacency matrix of size (k+j)*(k+j) includes the connection relationship among the (k+j) vertices.

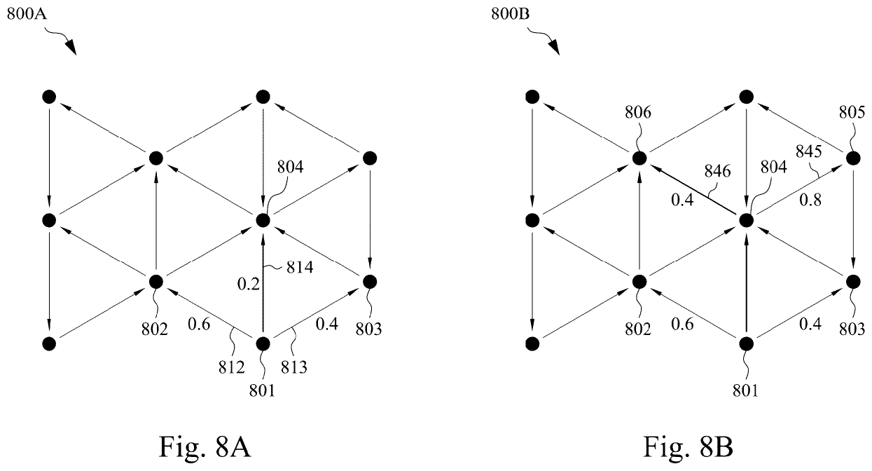

A description is provided with reference to FIG. 2 to FIG. 8B. FIG. 8A and FIG. 8B depict schematic diagrams of growing a minimum spanning tree according to some embodiments of the present disclosure. In some embodiments, color differences between every two adjacent basic vertices (such as, the vertices 704) can be calculated according to the color information of the basic vertices, as such a directed graph can be created from the mesh graph. For example, FIG. 8A and FIG. 8B illustrate portions 800A and 800B of the directed graph created from the mesh graph. In some embodiments, the two adjacent basic vertices refer to two basic vertices which are connected by an edge.

In some embodiments, each arrow symbols included in a directed graph points a basic vertex with larger value from the other basic vertex with smaller value. In the other embodiments, each arrow symbol included in the directed graph points a basic vertex with smaller value from the other basic vertex with larger value. Therefore, it is not intended to limit the present disclosure.

As shown in FIG. 8A, the values of 0.6, 0.4 and 0.2 at the edges 812˜814 show color differences from the basic vertex 801 to the basic vertices 802˜804. In some embodiments, based on the minimum spanning tree algorithm, the edge 814 is selected to minimize the weight.

As shown in FIG. 8B, the values of 0.8 and 0.4 at the edges 845˜846 show color differences from the basic vertex 804 to the basic vertices 805˜806. In some embodiments, based on the minimum spanning tree algorithm, the edge 846 is selected to minimize the weight.

As a result, the minimum spanning tree algorithm is executed to grow a minimum spanning tree, by exploring all basic vertices included in the directed graph created from the mesh graph 700.

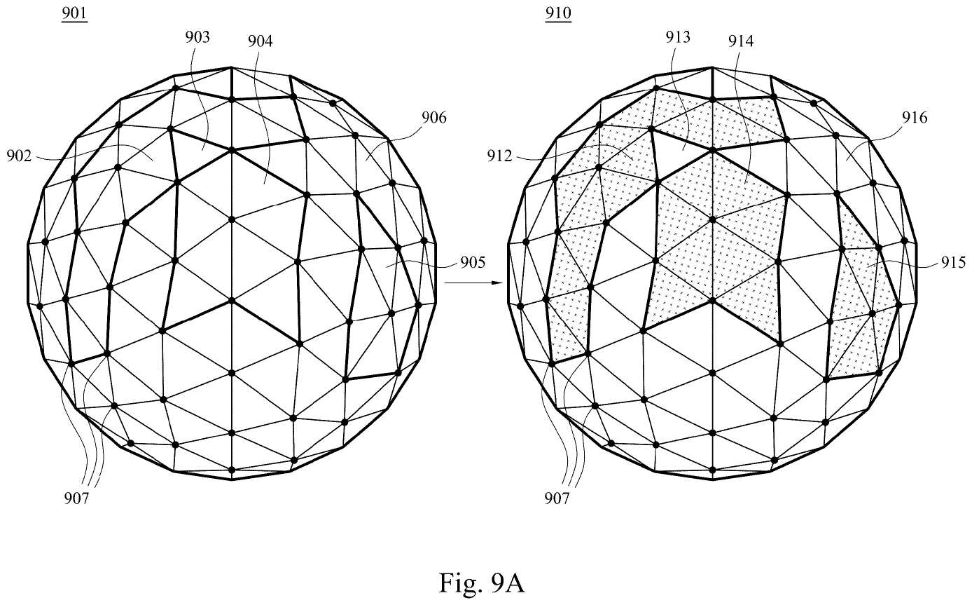

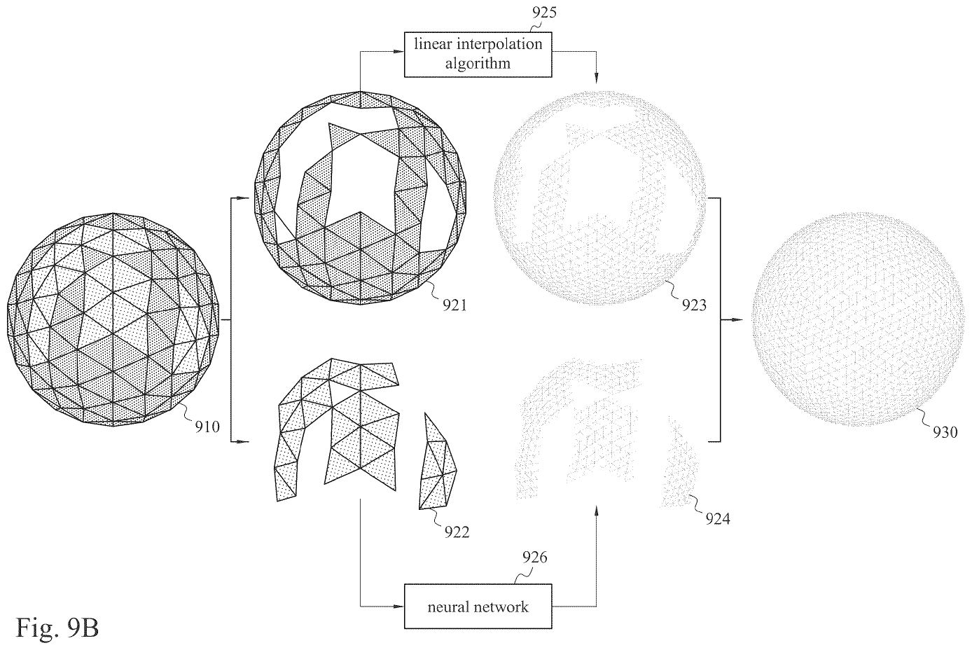

A description is provided with reference to FIG. 2 to FIG. 9A. FIG. 9A depicts a schematic diagram of determining a complexity of each of subsets 902˜906 of fragments according to some embodiments of the present disclosure. In some embodiments, each fragments are formed by basic vertices (such as, vertices 907), and the said basic vertices in the embodiments of FIG. 9A and FIG. 9B correspond to the basic vertices (such as, the vertices 704) in embodiments of FIG. 7 and the basic vertices (such as, the vertices 504) in embodiments of FIG. 5.

In some embodiments, the minimum spanning tree algorithm is executed to grow a minimum spanning tree 901 (which is represented by the thick lines as shown in FIG. 9A) based on the mesh graph 700. In some embodiments, the mesh graph 700 can be divided into the subsets 902˜906 of fragments according to the minimum spanning tree 901, and a visual feature complexity of each subset of fragments (such as, the subsets 902 of fragments) is determined by calculating a value of an average of color differences between every two adjacent basic vertices in the subset of fragments (such as, the subsets 902 of fragments) divided by an area of the subset of fragments (such as, the subsets 902 of fragments). Therefore, visual feature complexities of every subset of fragments can be obtained, and if a visual feature complexity of a subset of fragments is larger than a threshold (which can be implemented by a predetermined hyperparameter), it determines that the subset of fragments has high complexity. On the other hand, if a visual feature complexity of a subset of fragments is less than the threshold, it determines that the subset of fragments has low complexity. In the other embodiments, the visual feature complexity of each subset of fragments (such as, the subsets 902 of fragments) is determined by calculating entropy which is given by the following formula.

$${Entropy}^{p} = - {\sum }_{i} p ( {v}_{l} ) * log ( p ( {v}_{i} ) ) ,$$

In the above formula, the term of “Entropy^{p}” refers to the degree of disorder in the p-th subset, which can be considered as the visual feature complexity of the p-th subset in some embodiments. The term of “p(νᵢ)” refers to a proportion of the number of vertices with a color (or a greyscale) in the mesh graph the same as the color on the i-th vertex with respect to the number of all vertices in the mesh graph.

In some embodiments, as shown in mesh graph 910, the subsets 913, 916 of fragments have low complexities are considered as a first subgraph 921 of the mesh graph 910 (which corresponds to the mesh graph 700 in FIG. 7), and the subsets 912, 914˜915 of fragments have high complexities are considered as a second subgraph 922 of the mesh graph 910, as shown in FIGS. 9A and 9B.

In some embodiments, the first subgraph 921 includes the edges and the vertices (including the basic vertices with visual features and the virtual vertices without visual features) included in the subsets 913 and 916 of the fragments.

In some embodiments, as shown in FIG. 9B, the first subgraph 921, which has lower visual feature complexity than the second subgraph 922, is enhanced based on linear interpolation algorithm 925 to compensate the visual features of a subset of virtual vertices included in the first subgraph 921, thereby generating a first enhanced graph 923. In some embodiments, the first enhanced graph 923 includes the edges and the vertices (including the basic vertices with visual features which can be considered as a first subset of the basic vertices of the mesh graph and the virtual vertices with visual features which can be considered as a first subset of the virtual vertices of the mesh graph) included in the subsets 913 and 916 of the fragments.

In some embodiments, the second subgraph 922 includes the edges and the vertices (including the basic vertices with visual features which can be considered as a second subset of the basic vertices of the mesh graph and the virtual vertices without visual features which can be considered as a second subset of the virtual vertices of the mesh graph) included in the subsets 912, 914˜915 of the fragments. In some embodiments, an irregular region spherical visual feature convolution matrix is inherited from the aforementioned adjacency matrix which has a size of (k+j)*(k+j), while the irregular region spherical visual feature convolution matrix includes the edges included in the subsets 912, 914˜915 of the fragments without the edges included in the subsets 913 and 916 of the fragments.

In some embodiments, the second subgraph 922, which has higher visual feature complexity than the first subgraph 921, is enhanced based on neural network 926 to generate the visual features of a subset of virtual vertices included in the second subgraph 922, thereby generating a second enhanced graph 924. In some embodiments, the second enhanced graph 924 includes the edges and the vertices (including the basic vertices with visual features and the virtual vertices with visual features) included in the subsets 912, 914˜915 of the fragments.

In some embodiments, the neural network 926 is a non-linear spherical visual feature enhancement network which can be implemented by a graph convolution neural network including at least one layer given by:

$${Z}^{l} = A \cdot {F}^{l} \cdot {W}^{l}$$

In the above function, the term of “Z^{l}” refers to an output of the l-th layer of the graph convolution neural network, where the number l can be any positive integer. The term of “A” refers to the irregular region spherical visual feature convolution matrix. The term of “F^{l}” refers to the visual features of the second subgraph in the l-th layer (such as, the visual features of the second subgraph 922 in the first layer), and the term of “F^{l}” can considered as an input of l-th layer of the neural network 926. The term of “W^{l}” refers to the trainable weight matrix in the l-th layer. In some embodiments, if the neural network 926 consists of a layer, the feature matrix is an input of the layer of the neural network 926, and an output of the layer of the neural network 926 is the output of the neural network 926. In some embodiments, if the neural network 926 consists of more than one layer, the feature matrix is an input of a first layer of the neural network, the output of the l-th layer is an input of (l+1)-th layer, and an output of a last layer of the neural network 926 is the output of the neural network 926. For example, the second subgraph 922 is an input of a first layer of the neural network 926, and an output of the first layer is an input of a second layer of the neural network 926, and so on. The output of the last layer of the neural network 926 can be the second enhanced graph 924. As a result, the output of the neural network can be computed and can be considered as the second enhanced graph 924.

In some embodiments, the ground truth can be an image has a desired resolution (such as, 16K). In some embodiments, the loss function of the neural network 926 is given by:

$$\begin{matrix}C C {E}_{vert}^{p} = \frac{1}{n} {\sum }_{i = 1}^{n} {( {F}_{i}^{′} - {F}_{i} )}^{2} \\ CC {E}_{frag}^{p} = {( 1 - {\sum }_{i = 1}^{n} \frac{( 2 * A VG ( {F}_{i}^{′} ) * AV G ( {F}_{i} ) ) ( 2 * COV ( {F}_{i}^{′} , {F}_{i} ) )}{( A {VG ( {F}_{i}^{′} )}^{2} + A V {G ( {F}_{i} )}^{2} ) ( S {TD ( {F}_{i}^{′} )}^{2} + {STD ( {F}_{i} )}^{2} )} )}^{2} \\ Loss = {\sum }_{p = 1}^{m} ( C C {E}_{vert}^{p} + C C {E}_{frag}^{p} )\end{matrix}$$

In the above function, the term of

$$“ {CCE}_{vert}^{p} ”$$

refers to color compensation error for every vertices (such as, the first to n-th vertices) in included in the p-th subset of fragments. The term of “n” refers to the number of the vertices in included on the p-th subset of fragments. The term of “F′ᵢ” refers to an output visual features of the i-th vertex. The term of “Fᵢ” refers to a ground truth of the i-th vertex. The term of

$$“ {CCE}_{frag}^{p} ”$$

refers to local color compensation error for the p-th subset of fragments. The term of “AVG” refers to an average calculation. The term of “COV” refers to a convolution. The term of “STD” refers to standard deviation.

Therefore, an enhanced panoramic image 930 which has a desired resolution (such as, 16K) can be generated by combining the first enhanced graph 923 and the second enhanced graph 924.

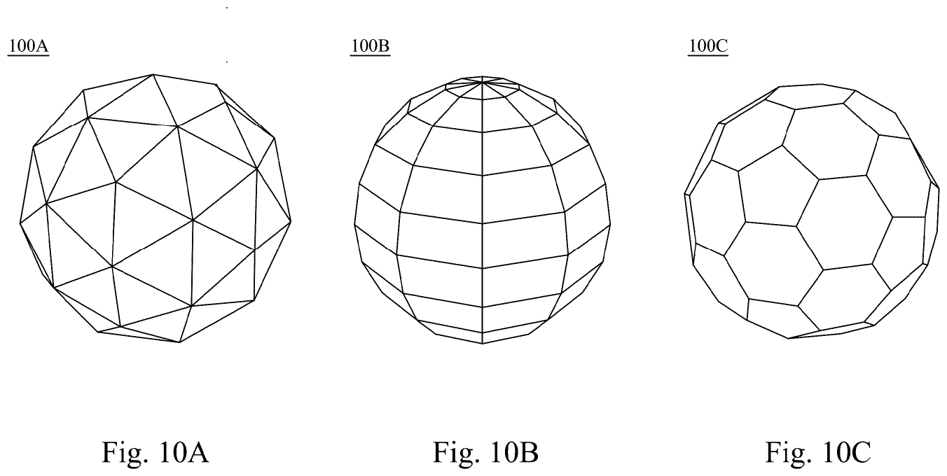

A description is provided with reference to FIG. 10A to 10C. FIG. 10A to FIG. 10C depict schematic diagrams of polygon spheres according to some embodiments of the present disclosure. As shown in FIG. 10A, the polygon sphere 100A is a spherical mesh that consists of equally sized triangles, which corresponds to the polygon sphere 500 in FIG. 5. In other embodiments, the polygon sphere 500 can be implemented by a UV sphere 100B, a pentagonal shpere100C that consists of equally sized pentagons or other polygon spheres, which it is not intended to limit the type of the polygon sphere 500.

Summary, the method 200 and device 300 for panoramic image enhancement can enhance and enlarge the resolution (such as, 4K or 8K) of the source spherical panoramic image to generate an enhanced spherical panoramic image which has the desired resolution (such as, 16K).

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method for panoramic image enhancement, comprising:
receiving a source image represented in a spherical format;
creating a polygon sphere;
creating a mesh graph according to the polygon sphere and information of the source image;
performing visual complexity analysis on the mesh graph to determine a first subgraph of the mesh graph and a second subgraph of the mesh graph which has higher visual complexity than the first subgraph;
enhancing information of the first subgraph based on a linear interpolation algorithm to generate a first enhanced graph;
enhancing information of the second subgraph based on a neural network to generate a second enhanced graph; and
combining the first enhanced graph and the second enhanced graph to generate an enhanced panoramic image.

2. The method of claim 1, wherein step of performing the visual complexity analysis on the mesh graph comprising:
calculating color differences between every two adjacent vertices to create a directed graph from the mesh graph;
growing a minimum spanning tree based on the directed graph;
dividing a plurality of fragments on the mesh graph into a plurality of subsets of the fragments according to the minimum spanning tree;
calculating visual feature complexities of the subsets of the fragments; and
determining the first subgraph and the second subgraph according to the visual feature complexities of the subsets of the fragments.

3. The method of claim 1, wherein the mesh graph comprises a plurality of basic vertices with a plurality of visual features and a plurality of virtual vertices without any visual feature.

4. The method of claim 3, wherein step of enhancing the information of the first subgraph comprises:
generating a plurality of features of a first subset of the virtual vertices included in the first subgraph, by using the linear interpolation algorithm, according to the visual features of the basic vertices.

5. The method of claim 3, wherein step of enhancing the information of the second subgraph comprises:
aggregating the visual features of the basic vertices, by the neural network, to generate a plurality of features of a second subset of the virtual vertices included in the second subgraph.

6. The method of claim 3, wherein the visual features of the basic vertices and a plurality of vertex features of the basic vertices and the virtual vertices are given by a feature matrix, and wherein connection relationship among the basic vertices and the virtual vertices is given by an adjacency matrix.

7. The method of claim 6, wherein step of enhancing the information of the second subgraph comprises:
computing an output of the neural network as the second enhanced graph, wherein the neural network is given by:
$${Z}^{l} = A \cdot {F}^{l} \cdot {W}^{l}$$
where a term of “Z^{l}” referring to an output of l-th layer, a term of “A” referring to the adjacency matrix, a term of “F^{l}” referring to an input of the l-th layer, and a term of “W^{l}” referring to a trainable weight matrix in the l-th layer,
wherein if the neural network consists of a layer, the feature matrix is an input of a layer of the neural network, and wherein an output of the layer of the neural network is the output of the neural network; and
wherein if the neural network consists of more than one layer, the feature matrix is an input of a first layer of the neural network, wherein the output of the l-th layer is an input of (l+1)-th layer, and wherein an output of a last layer of the neural network is the output of the neural network.

8. The method of claim 1, wherein step of creating the mesh graph comprises:
inheriting a structure of the polygon sphere composed of a plurality of basic vertices and a plurality of virtual vertices as a data structure; and
projecting the information of the source image to the basic vertices as a plurality of visual features of the basic vertices,
and wherein step of creating the polygon sphere comprises:
creating the polygon sphere comprising a plurality of vertices, wherein the number of the vertices corresponds to a resolution of the enhanced panoramic image.

9. The method of claim 1, wherein the source image and the enhanced panoramic image are spherical panoramic images.

10. The method of claim 1, wherein the enhanced panoramic image has a resolution higher than a resolution of the source image.

11. A device for panoramic image enhancement, comprising:
a memory, configured to store data and instructions; and
a processing circuit, coupled to the memory to access the data and the instructions stored in the memory to execute:
receive a source image represented in a spherical format;
create a polygon sphere;
create a mesh graph according to the polygon sphere and information of the source image;
perform visual complexity analysis on the mesh graph to determine a first subgraph of the mesh graph and a second subgraph of the mesh graph which has higher visual complexity than the first subgraph;
enhance information of the first subgraph based on a linear interpolation algorithm to generate a first enhanced graph; and
enhance information of the second subgraph based on a neural network to generate a second enhanced graph; and
combine the first enhanced graph and the second enhanced graph to generate an enhanced panoramic image.

12. The device of claim 11, wherein the processing circuit further executes:
calculate color differences between every two adjacent vertices to create a directed graph from the mesh graph;
grow a minimum spanning tree based on the directed graph;
divide a plurality of fragments on the mesh graph into a plurality of subsets of the fragments according to the minimum spanning tree;
calculate visual feature complexities of the subsets of the fragments; and
determine the first subgraph and the second subgraph according to the visual feature complexities of the subsets of the fragments.

13. The device of claim 11, wherein the mesh graph comprises a plurality of basic vertices with a plurality of visual features and a plurality of virtual vertices without any visual feature.

14. The device of claim 13, wherein the processing circuit further executes:
generate a plurality of features of a first subset of the virtual vertices included in the first subgraph, by using the linear interpolation algorithm, according to the visual features of the basic vertices.

15. The device of claim 13, wherein the processing circuit further executes:
aggregate the visual features of the basic vertices, by the neural network, to generate a plurality of features of a second subset of the virtual vertices included in the second subgraph.

16. The device of claim 13, wherein the visual features of the basic vertices and a plurality of vertex features of the basic vertices and the virtual vertices are given by a feature matrix, and wherein connection relationship among the basic vertices and the virtual vertices is given by an adjacency matrix.

17. The device of claim 16, wherein the processing circuit further executes:
compute an output of the neural network as the second enhanced graph, wherein the neural network is given by:
$${Z}^{l} = A \cdot {F}^{l} \cdot {W}^{l}$$
where a term of “Z^{l}” referring to an output of l-th layer, a term of “A” referring to the adjacency matrix, a term of “F^{l}” referring to an input of the l-th layer, and a term of “W^{l}” referring to a trainable weight matrix in the l-th layer,
wherein if the neural network consists of a layer, the feature matrix is an input of a layer of the neural network, and wherein an output of the layer of the neural network is the output of the neural network; and
wherein if the neural network consists of more than one layer, the feature matrix is an input of a first layer of the neural network, wherein the output of the l-th layer is an input of (l+1)-th layer, and wherein an output of a last layer of the neural network is the output of the neural network.

18. The device of claim 11, wherein the processing circuit further executes:
generate a data structure of the mesh graph by inheriting a structure of the polygon sphere composed of a plurality of basic vertices and a plurality of virtual vertices;
project the information of the source image to the basic vertices as a plurality of visual features of the basic vertices; and
create the polygon sphere comprising a plurality of vertices, wherein the number of the vertices corresponds to a resolution of the enhanced panoramic image.

19. The device of claim 11, wherein the source image and the enhanced panoramic image are spherical panoramic images.

20. The device of claim 11, wherein the enhanced panoramic image has a resolution higher than a resolution of the source image.
